(19) United States
(12) Patent Application Publication
(10) Pub. No.: US 2018/0363790 A1
(43) Pub. Date: Dec. 20, 2018

(54) UNIVERSAL AIR PRESSURE VALVE MODULE

(71) Applicant: BANZA STAMPING INDUSTRY CORP., Su'ao Township (TW)

(72) Inventors: Li-Wei Chen, Su'ao Township (TW); Cole Krebs, Su'ao Township (TW)

(73) Assignee: BANZA STAMPING INDUSTRY CORP., Su'ao Township (TW)

(21) Appl. No.: 15/623,614

(22) Filed: Jun. 15, 2017

(51) Int. Cl. F16K 17/04; F16K 31/122; G05D 16/10

(52) U.S. Cl. CPC F16K 17/04; G05D 16/103; F16K 31/1226; F16K 31/1221

(57) ABSTRACT

An universal air pressure valve module has a hollow shell, a sealing element, a piston and an elastic element. The sealing element is mounted slidably in a low pressure chamber of the shell. The piston is mounted slidably in the low chamber and abuts against the sealing element. The elastic element is mounted longitudinally in the low pressure chamber and presses against the piston. With the pre-assembling the sealing element, the piston and the elastic element in the shell, the universal air pressure valve module is modularized and is easy to be assembled in a desired device.

### BACKGROUND OF THE INVENTION

### 1. Field of the Invention

The present invention relates to an air pressure valve, and in particular to an universal air pressure valve module that is modularization and is adapted for different devices.

### 2. Description of the Prior Arts

Air pressure valves are used to reduce the input pneumatic pressure to a desired output pneumatic pressure and are used widely in various devices. A conventional air pressure valves comprises piston, sealing element, elastic element and so on. Those elements need to be assembled into an applicable device to provide function. However, different devices have different dimension so that the elements of the conventional air pressure valves have to be made in different sizes to fit into different devices. Thus, the manufacturing process for the conventional air pressure valve is more complicated and is not adapted for mass production.

To overcome the shortcomings, the present invention provides an universal air pressure valve module to mitigate or obviate the aforementioned problems.

### SUMMARY OF THE INVENTION

The main objective of the present invention is to provide an universal air pressure valve module that is suitable for different devices. The universal air pressure valve module has a hollow shell, a sealing element, a piston and an elastic element. The sealing element is mounted slidably in a low pressure chamber of the shell. The piston is mounted slidably in the low chamber and abuts against the sealing element. The elastic element is mounted longitudinally in the low pressure chamber and presses against the piston. With the pre-assembling the sealing element, the piston and the elastic element in the shell, the universal air pressure valve module is modularized and is easy to be assembled in a desired device.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an universal air pressure valve module in accordance with the present invention;

FIG. 2 is an operational side view in partial section of the universal air pressure valve module in FIG. 1, shown in closed state;

FIG. 3 is an operational side view in partial section of the universal air pressure valve module in FIG. 1, shown in open state;

FIG. 4 is an operational exploded perspective view of the universal air pressure valve module in FIG. 1 mounted in a first device; and

FIG. 5 is an operational exploded perspective view of the universal air pressure valve module in FIG. 1 mounted in a second device.

### DETAILED DESCRIPTION OF THE EMBODIMENTS

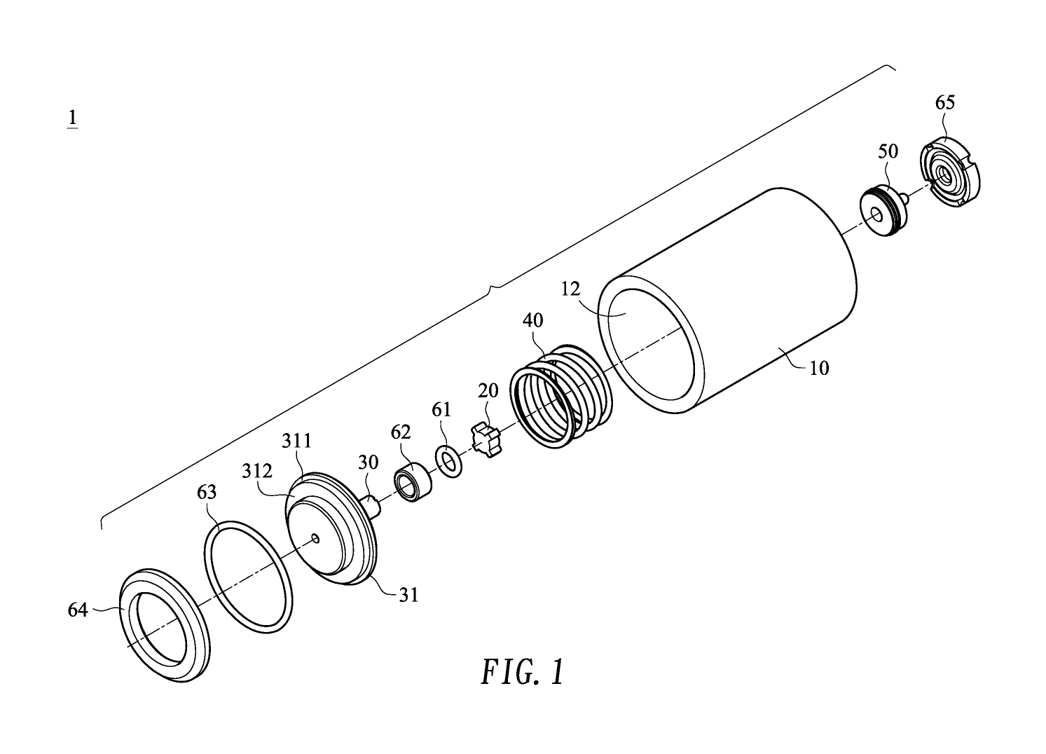

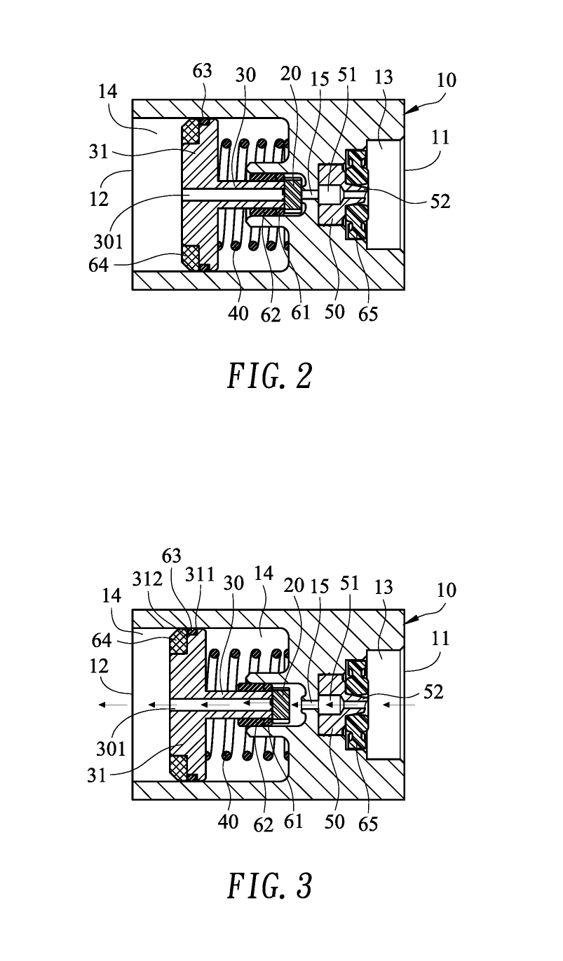

With reference to FIGS. 1 and 2, an universal air pressure valve module 1 in accordance with the present invention comprises a shell 10, a sealing element 20, a piston 30, an elastic element 40, an optional puncturing element 50 and an optional sealing assembly.

With reference to FIG. 2, the shell 10 is hollow and has an inlet 11, an outlet 12, a high pressure chamber 13, a low pressure chamber 14 and a passage 15. The high pressure chamber 13 is disposed adjacent to and communicates with the inlet 11. The low pressure chamber 14 is disposed adjacent to and communicates with the outlet 12. The passage 15 is disposed between and communicates with the high pressure chamber 13 and the low pressure chamber 14.

With reference to FIGS. 1 and 2, the sealing element 20 is mounted slidably in the low pressure chamber 14 and selectively blocks the passage 15 to selectively close a flow path from the high pressure chamber 13 to the low pressure chamber 14.

The piston 30 is mounted slidably in the low pressure chamber 14, abuts against the sealing element 20 and has an central orifice 301 aligning with the passage 15 of the shell 10. In one embodiment, the piston 30 has an enlarged head 31 abuts against an inside wall of the low pressure chamber 14. The enlarged head 31 has a first annular recess 311 and a second annular recess 312 formed on an outside wall of the enlarged head 31 in sequence. The first annular recess 311 has a diameter larger than that of the second annular recess 312.

The elastic element 40 is mounted longitudinally in the low pressure chamber 14 and presses against the piston 30. In one embodiment, the elastic element 40 is mounted around the piston 30 and is compressed between the enlarged head 31 and the inside wall of the low pressure chamber 14. The elastic element 40 may be a spring, a plurality of resilient washers and so on.

The puncturing element 50 is mounted in the high pressure chamber 13 and has a central hole 51 and a needle part 52. The central hole 51 is formed through the puncturing element 50 and aligns with the passage 15. The needle part 52 is formed on an end of the puncturing element 50 to selectively puncture through the outlet of the high pressure source.

The sealing assembly is mounted in the shell 10 to provide air tight function and may comprise an inner O-ring 61, an inner block 62, an outer O-ring 63, an outer block 64 and a holder 65. The inner O-ring 61 is mounted in the low pressure chamber 14 and abuts against the sealing element 20 and the inside wall of the low pressure chamber 14. The inner block 62 is mounted in the low pressure chamber 14 and abuts against the inner O-ring 61 and the inside wall of the low pressure chamber 14 to hold the inner O-ring 61. The outer O-ring 63 is mounted in the first annular recess 311 of the piston 30 and abuts against the inside wall of the low pressure chamber 14. The outer block 64 is mounted in the second annular recess 312 of the piston and abuts against the inside wall of the low pressure chamber 14 to hold outer O-ring 63. The holder 65 is mounted around the needle part 52 of the puncturing element 50 to hold the puncturing element 50. The O-rings may be altered by disk, cone, washer, plate, ring bumper and so on.

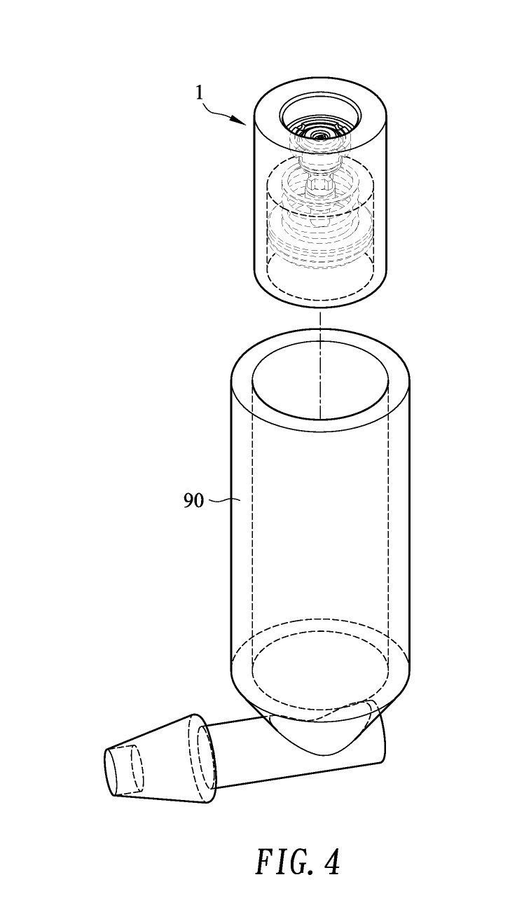

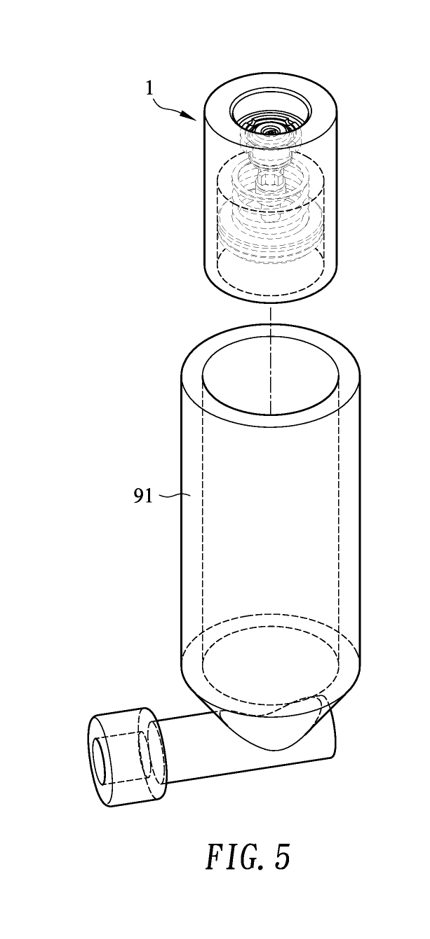

With reference to FIGS. 4 and 5, the universal air pressure valve module 1 as described is applicable to different devices 90, 91 to regulate inlet pressure from the high pressure source to a desired outlet pressure to the downstream device

With reference to FIGS. 2 and 3, in operation, universal air pressure valve module 1 as described is connected between the high pressure source and a downstream device. The inlet 11 of the shell 10 is connected to the high pressure source. The outlet 12 of the shell 10 is connected to the downstream device.

With reference to FIG. 2, the universal air pressure valve module 1 as described is in a closed state. When the gas pressure in the downstream device is at the desired pressure, the gas pressure on the outlet 12 is sufficiently high to offset the force of the elastic element 40. Then the piston 30 presses the sealing element 20 to abut against the opening of the passage 15 to stop the gas flow from the inlet 11 to the outlet 12. Therefore, the gas in the high pressure source is stopped from flowing into the downstream device in the closed state.

With further reference to FIG. 3, the universal air pressure valve module 1 as described is in an open state. The gas pressure in the downstream device decreases so that the gas pressure on the outlet 12 is not high enough to offset the force of the elastic element 40. Then the elastic element 40 pushes the piston 30 to move toward the outlet 12 so that the sealing element 20 leaves the opening of the passage 15 to allow the gas to flow from the inlet 11 to the outlet 12 through the central hole 51 of the puncturing element 50, the passage 15, the gap between the sealing element 20 and the inside wall of the low pressure chamber 14, and the central orifice 301 of the piston 30. Therefore, the gas in the high pressure source flows into the downstream device in the open state to increase the gas pressure in the downstream device. When the gas pressure in the downstream device is sufficiently high again, the universal air pressure valve module 1 as described is back to the closed state.

With the universal air pressure valve module 1 as described being modularization in the shell 10, the universal air pressure valve module 1 as described is assembled in advance and then is easy to be mounted in different devices to regulate the air pressure. Moreover, except for spring and puncturing element 50, all of the elements may be made of plastic so that the universal air pressure valve module 1 are easy to made by injection molding to allow quick and mass production. In addition, the annular recesses 311 and 312 of the piston 30 are formed during injection molding so that no more manufacturing process is performed to form the annular recesses 311 and 312 for disposing the O-ring. Thus, the manufacturing process is more simplified.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An universal air pressure valve module comprising:
a hollow shell having
an inlet;
an outlet;
a high pressure chamber disposed adjacent to and communicating with the inlet;
a low pressure chamber disposed adjacent to and communicating with the outlet; and
a passage disposed between and communicating with the high pressure chamber and the low pressure chamber;
a sealing element mounted slidably in the low pressure chamber and selectively blocking the passage to selectively close a flow path from the high pressure chamber to the low pressure chamber;
a piston mounted slidably in the low pressure chamber, abutting against the sealing element and having an central orifice aligning with the passage of the shell; and
an elastic element mounted longitudinally in the low pressure chamber and pressing against the piston.

2. The universal air pressure valve module as claimed in claim 1 further comprising a puncturing element mounted in the high pressure chamber and having
a central hole formed through the puncturing element and aligning with the passage; and
a needle part formed on an end of the puncturing element.

3. The universal air pressure valve module as claimed in claim 2 further comprising a holder mounted around the needle part of the puncturing element to hold the puncturing element.

4. The universal air pressure valve module as claimed in claim 1 further comprising a sealing assembly, wherein
the piston has
an enlarged head abutting against an inside wall of the low pressure chamber;
a first annular recess and a second annular recess formed on an outside wall of the enlarged head in sequence, wherein the first annular recess has a diameter larger than that of the second annular recess; and
the sealing assembly has
outer O-ring mounted in the first annular recess of the piston and abutting against the inside wall of the low pressure chamber; and
an outer block mounted in the second annular recess of the piston and abutting against the inside wall of the low pressure chamber to hold outer O-ring.

5. The universal air pressure valve module as claimed in claim 2 further comprising a sealing assembly, wherein
the piston has
an enlarged head abutting against an inside wall of the low pressure chamber;
a first annular recess and a second annular recess formed on an outside wall of the enlarged head in sequence, wherein the first annular recess has a diameter larger than that of the second annular recess; and
the sealing assembly has
outer O-ring mounted in the first annular recess of the piston and abutting against the inside wall of the low pressure chamber; and
an outer block mounted in the second annular recess of the piston and abutting against the inside wall of the low pressure chamber to hold outer O-ring.

6. The universal air pressure valve module as claimed in claim 3 further comprising a sealing assembly, wherein
the piston has
an enlarged head abutting against an inside wall of the low pressure chamber;
a first annular recess and a second annular recess formed on an outside wall of the enlarged head in sequence, wherein the first annular recess has a diameter larger than that of the second annular recess; and
the sealing assembly has
outer O-ring mounted in the first annular recess of the piston and abutting against the inside wall of the low pressure chamber; and
an outer block mounted in the second annular recess of the piston and abutting against the inside wall of the low pressure chamber to hold outer O-ring.

7. The universal air pressure valve module as claimed in claim 1 further comprising a sealing assembly, wherein the sealing assembly has
an inner O-ring mounted in the low pressure chamber and abutting against the sealing element and an inside wall of the low pressure chamber; and
an inner block mounted in the low pressure chamber and abutting against the inner O-ring and the inside wall of the low pressure chamber to hold the inner O-ring.

8. The universal air pressure valve module as claimed in claim 2 further comprising a sealing assembly, wherein the sealing assembly has
an inner O-ring mounted in the low pressure chamber and abutting against the sealing element and an inside wall of the low pressure chamber; and
an inner block mounted in the low pressure chamber and abutting against the inner O-ring and the inside wall of the low pressure chamber to hold the inner O-ring.

9. The universal air pressure valve module as claimed in claim 3 further comprising a sealing assembly, wherein the sealing assembly has
an inner O-ring mounted in the low pressure chamber and abutting against the sealing element and an inside wall of the low pressure chamber; and
an inner block mounted in the low pressure chamber and abutting against the inner O-ring and the inside wall of the low pressure chamber to hold the inner O-ring.

10. The universal air pressure valve module as claimed in claim 4, wherein the sealing assembly has
an inner O-ring mounted in the low pressure chamber and abutting against the sealing element and the inside wall of the low pressure chamber; and
an inner block mounted in the low pressure chamber and abutting against the inner O-ring and the inside wall of the low pressure chamber to hold the inner O-ring.

11. The universal air pressure valve module as claimed in claim 5, wherein the sealing assembly has
an inner O-ring mounted in the low pressure chamber and abutting against the sealing element and the inside wall of the low pressure chamber; and
an inner block mounted in the low pressure chamber and abutting against the inner O-ring and the inside wall of the low pressure chamber to hold the inner O-ring.

12. The universal air pressure valve module as claimed in claim 6, wherein the sealing assembly has
an inner O-ring mounted in the low pressure chamber and abutting against the sealing element and the inside wall of the low pressure chamber; and
an inner block mounted in the low pressure chamber and abutting against the inner O-ring and the inside wall of the low pressure chamber to hold the inner O-ring.

13. The universal air pressure valve module as claimed in claim 1, wherein the shell, the sealing element and the piston are made of plastic.

14. The universal air pressure valve module as claimed in claim 1, wherein the shell, the sealing element and the piston are made by injection molding.

15. The universal air pressure valve module as claimed in claim 1,
wherein the elastic element is a spring.
